(19) United States
(12) Patent Application Publication
(10) Pub. No.: US 2008/0215523 A1
(43) Pub. Date: Sep. 4, 2008

(54) METHOD FOR ASSOCIATION CHECKING OF STRUCTURED DATA SETS FROM WHICH PATIENT IDENTIFICATION DATA CAN BE DETERMINED IN A PATIENT ADMINISTRATION SYSTEM WITH ELECTRONIC PATIENT RECORDS

(76) Inventors: Thomas Hartwig, Baiersdorf (DE); Volker Schmidt, Erlangen (DE); David Wolfgang Eberhard schmidt, Erlangen (DE); Dominic Pascal Schmidt, Erlangen (DE)

Correspondence Address: SCHIFF HARDIN, LLP;PATENT DEPARTMENT, 6600 SEARS TOWER, CHICAGO, IL, 60606-6473, US

(21) Appl. No.: 11/836,845

(22) Filed: Aug. 10, 2007

(30) Foreign Application Priority Data
Aug. 10, 2006 (DE) 10 2006 037 563.7

(51) Int. Cl. G06F 17/30

(52) U.S. Cl. 707/1; 707/E17.001

(57) ABSTRACT

In a method for association checking of structured data sets from which patient identification data can be determined in a patient administration system with electronic patient records that respectively include a structured base data set containing patient identification data upon an access to a patient record and/or at least one structured data set thereof, a comparison of patient identification data determined from at least the just-accessed structured data set and/or one structured data set already opened with the patient identification data of the base data set ensues. A warning is output to a user if correspondence does not exist.

### BACKGROUND OF THE INVENTION

1. Field of the Invention

The present invention concerns a method for association checking of structured data sets from which patient identification data can be determined in a patient administration system using electronic patient records each containing a structured base data set that includes patient identification data.

2. Description of the Prior Art

During his or her life a patient may interface with a number of different medical facilities (for example hospitals, clinics, physicians, . . . ). In each of these facilities data are created that identify the health history and the health state of the patient. It is frequently desired to exchange such data among the facilities, or to allow a common usage or a common viewing spanning across institutions.

This desire allows for the introduction of a central longitudinal patient record which is available to the institutions via at least one central server. The term “longitudinal” here is used herein with regard to the course of time. In addition to a base data set that comprises the most important patient identification data, such a longitudinal patient record (also called a network record) also includes a number of documents (for example diagnoses in text form, images of various acquisition modalities, measurement data, etc.) that increase (i.e, are added to) over time. The network record can also include a master patient index and refer to patient records and data in other systems.

The medical facilities typically operate independently of one another. Thus patient-identifying data will likely be stored differently in the different systems. Examples for such differences are name abbreviations, different notations, different umlaut representations, but also the changing of names (for example due to a marriage). Incorrect or incomplete entries, for example when making entries under stress, are also a frequent source of error.

Due to the different patient identification data in different systems, the risk exists of patients being confused with one another, in particular documents being filed in the wrong patient record. A further problem results from the independence of viewing programs and access programs to patient records, whereby upon switching to a new patient, the patient record data of the previously-displayed patient can furthermore remain on the screen. For the patient, this presents the risk that false medical conclusions and diagnoses may be made. Not only can errors accordingly arise in the entry of data sets in the patient record, but also in the access to already-entered data sets, for example by an unauthorized viewer.

### SUMMARY OF THE INVENTION

An object of the present invention is to provide a method wherein the risk to the patient due to incorrect association of medical data can be reduced.

This object is achieved in a method of the aforementioned type wherein, in accordance with the present invention, upon the occurrence of access to a patient record and/or at least one structured data set that, a comparison is made between patient identification data from at least the just-accessed structured data set and/or one structured data set that was already opened, and the patient identification data of the base data set. A warning is output to a user if correspondence does not exist.

The method thus makes use of the fact that data sets ever more frequently exist in structured form, meaning that specific data can be extracted from them (patient identification data in the present case). The term “structured data sets” is used herein broadly as encompassing any unit of data that is configured in a structured form. For example, a document (in particular according to the Sciphox standard or according to the XML standard or the xDT standard or the XDS standard or the DICOM standard or the HL7 standard) and/or data of an electronically readable card (in particular an electronic health card and/or a ViTaX card and/or a health insurance card) and/or an electronically-readable identification (for example personal identification or driver's license) and/or a credit card) and/or an electronic prescription can exist as a structured data set. A structured data set in particular can be a document. It can be a text file, and/or image data (for example). These documents conventionally contain patient identification data (for example in the form of a header) that can be extracted from the documents via a suitable software. The same naturally applies for the other cited structured data sets such as, for example, data of an electronically-readable card or electronic prescriptions (in the following the latter are considered as documents).

In the inventive method the fact that patient identification data can both be extracted from the structured data sets and exist as part of the patient record in the form of the base data set (which is viewed as current and correct) is now used for association checking. A comparison is thereby enabled. In the context of the inventive method this comparison occurs upon an access to the patient record as occurs in the problem cases discussed above, all of which involve opening of a patient record or of a structured data set thereof or the placement of a new data set. In all of these cases a warning should be output that an incorrect association in a patient record exists, so incorrect medical conclusions can be prevented in advance. Not only are possible association errors indicated, but also the possibility of the patient identification data being in the correct record, but being non-timely in the system or in a document. For example, if the patient identification data in the base data set are updated (for example at the indication of the patient), this does not yet mean that this information is also updated in the other structured documents in the patient record. Given placement of a locally-present structured data set, it can also possibly be noted that the local system is operating with outdated patient identification data. After receipt of the warning, the data can be checked and an updating can ensue as needed.

It is appropriate for the comparison to ensue upon the placement of a structured document in a patient record and/or upon opening a structured document from a patient record and/or upon reading (importing) the structured document of an electronically-readable card.

If the comparison ensues upon placement of a structured document in a patient record, it is additionally immediately checked again whether the structured document is actually associated with the patient in whose patient record it should be placed. An incorrect sorting of structured data sets can already be prevented by the ensuing warning. The comparison can likewise ensue in an automated manner upon opening of a document from a patient record. If the user subsequently accesses a structured document that is already stored in the patient record and should be associated with the patient, for security it is nevertheless checked one more time whether this document has not possibly been incorrectly placed. If an error exists, a warning is output and the viewing person is made aware of the discrepancy.

Such a comparison also can ensue upon opening of a patient record, but in this case with regard to an already open data set or a data set located in processing. For example, if a set of measurement data that is displayed in a viewer has been opened by the user and a patient record is then opened or, respectively, the patient record is altered, a warning can be submitted to the user that a file is still open that concerns a different patient. Here association difficulties can also be advantageously prevented. The comparison also can ensue upon reading of the data of an electronically-readable card. If a structured data set is retrieved (for example via a card reader) from such a card (for example a health insurance card), it is thus reasonable to check at this point in time whether the patient identification data coincide with those of a patient record opened at the moment.

The possibility additionally exists for the comparison to ensue upon a storage of an altered data set in a patient record. Such a comparison is in particularly meaningful when the patient identification data were altered for whatever reason during the processing. A warning can then be output if applicable when the patient identification data no longer correspond to those of the base data set. A further reduction of association errors is thereby achieved.

If the comparison is not successful, the user thus receives a warning. A more detailed check of the association can be implemented based on this warning. For example, apparent clerical errors can be corrected. A further inquiry to the patient himself or herself is possible, if needed. The user is accordingly aware of the problem and can initiate corresponding measures. In a further embodiment of the invention, a separate data set is established for the comparison for each document type or each data set type. For example, a health insurance card may contain no information with regard to gender.

In a further embodiment of the invention, the comparison can ensue using a comparison data set with at least one patient identification datum. The comparison data set can include the first name and/or the last name and/or the birth date and/or the gender and/or the address and/or a medical characteristic and/or other patient-specific information of a patient. Through the comparison data set it is accordingly established which patient identification data from the base data set should be compared with patient identification data from the structured data set. Since long ago not all structured data sets also contained information beyond the name of the patient, in the practical application the comparison data set should be reduced to a minimum of patient identification data. For purpose, this the first name and the last name of the patient are appropriately selected as a minimal comparison data set. The probability can thus be reduced that a comparison already fails at the non-existence of a patient identification datum in the structured data set.

In a further embodiment of the inventive method, upon the occurrence of a warning with regard to a data set placed in the patient record, the data set is automatically or manually marked and/or entered into a list (stored in the patient record) of data sets with association errors. Accordingly either a marking of the data set as possibly incorrectly associated is effected, such that an indication of a possible association error is already presented upon viewing of the documents in the patient record, or a list (for example in the form of a log file) is attached in which the name or a reference to the corresponding structured data set is stored. The point in time of the error and/or the type of the error and/or the user at fault for the error occurred and/or possible correction measures taken can be additionally recorded in the list with particular advantage.

If the patient record is stored on at least one central server, the access will typically ensue via a communication connection (in particular the Internet) from a local computer. An access to a number of medical facilities is accordingly possible.

The above object also is achieved in accordance with the present invention by a computer having an input device and a display device that is fashioned for implementation of the method described above. For this purpose, the computer can execute, for example, a suitable software that regulates communication with a central server on which the patient records are stored.

### BRIEF DESCRIPTION OF THE DRAWINGS

FIG. 1 is a block diagram of the basic components of a patient administration system with electronic patient records.

FIG. 2 is a flowchart of an embodiment of the inventive method.

### DESCRIPTION OF THE PREFERRED EMBODIMENTS

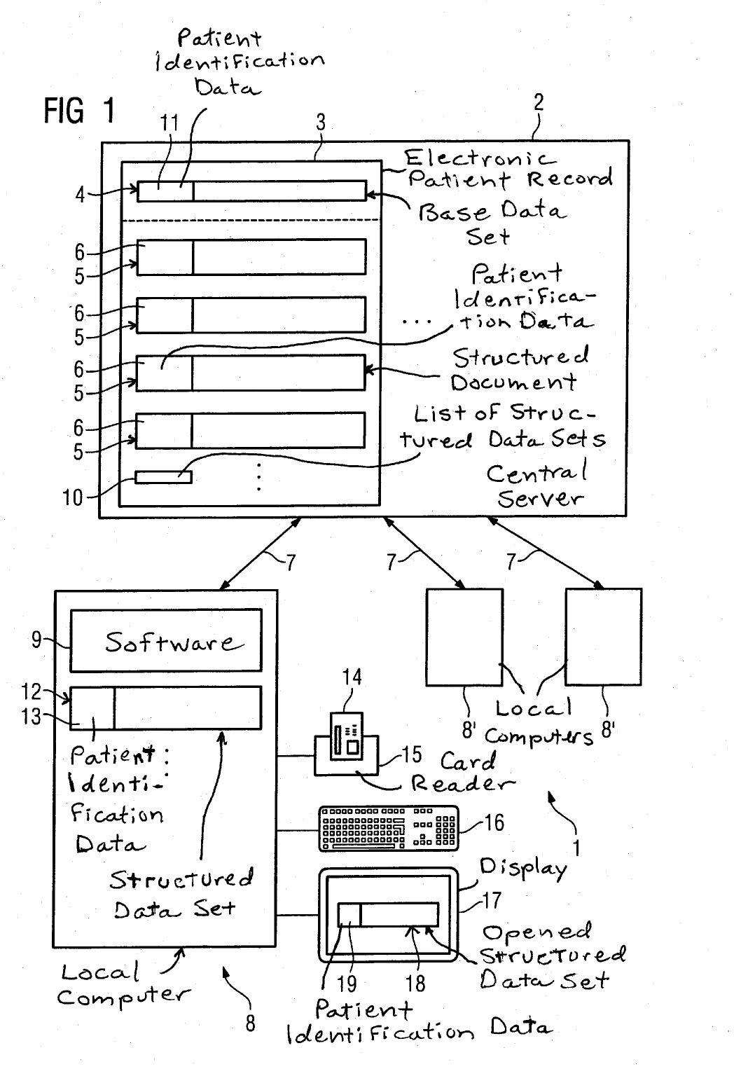

FIG. 1 shows a patient administration system 1 that can be designed, for example, as a master patient index system. Such a master patient index system administers different patient identities in various external subsystems. The network record (patient record) of a patient includes a master-patient index (in the form of a software packet) or interacts with such an index. The network or the master-patient index administers or refers back to the data and references to data in external systems that belong to this patient and that can be accessed to this reference. The patient administration system 1 has at least one central server 2 on which are stored a number of electronic patient records 3 (of which only one is shown for clarity). The patient record 3 includes a base data set 4. The base data set 4 is itself a structured data set from which patient identification data 11 can be determined. The base data set 4 is continuously kept current from a central point so that alterations (such as, for example, a changing of the name upon marriage, a move or the like) are always noted there.

Furthermore, a number of structured documents 5 that can be, for example, anatomical exposures, measurement data, diagnosis reports or electronic prescriptions are stored in the electronic patient record 3. Contained in the documents 5 are different patient identification data 6 that can easily be determined from the documents se due to the structuring of the documents 5.

The placed documents in the patient record 3 over time should able to be retrieved by various medical institutions or facilities. For this purpose, a communication connection 7 is provided that allows local computers 8, 8′ of various medical facilities to access the patient record 3 and the documents 5 stored therein. For simplification, only the local computer 8 is shown in FIG. 1. In it is stored as software 9 by means of which the access to the server 2 and the patient records 3 stored thereupon ensues. The software 9 is additionally fashioned to implement the inventive method, meaning that, given an access to the patient record or a structured data set, a comparison of the patient identification data is implemented, and a warning is output to a user dependent on the comparison result. It is additionally possible to mark a structured data set stored in the patient record 3 or to enter said structured data set in a list 10 of structured data sets with association errors, which list 10 is likewise stored in the patient record 3.

Structured data sets 12 (of which only one example is shown) are additionally stored or are present on the local computer. The locally stored structured data sets 12 include patient identification data 13 that can be determined from the data sets 12. They can be, for example, diagnosis reports in text form, measurement or image data from medical facilities, an electronic prescription just generated, or structured data of an electronically-readable card 14 that was read by a card reader 15 associated with the computer 8.

Furthermore, the computer 8 has an input device 16 as well as a display device 17, here a monitor. An opened structured data set 18 is currently displayed on the display device 17. Patient identification data 19 are likewise present in the opened structured data set 18, but the patient identification data 19 do not necessarily have to be shown on the display device 17.

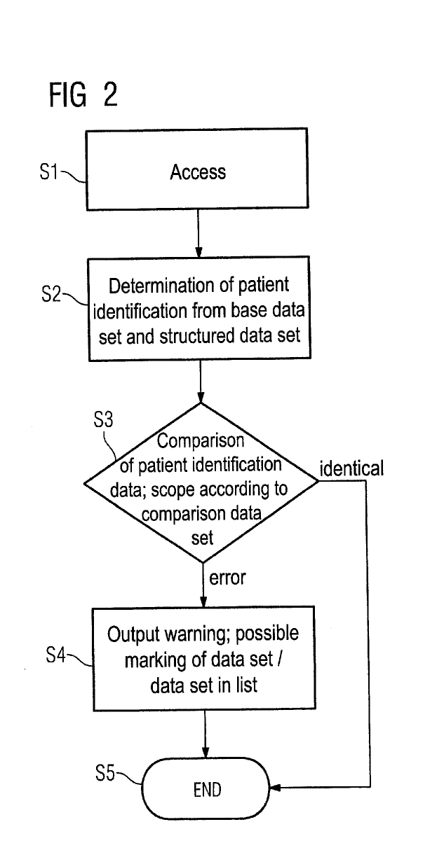

FIG. 2 shows a flowchart of an embodiment of the inventive method. The method begins in step S1 with an access to a patient record or at least one structured data set. Such an access beginning the method can be, for example, the placement of a structured document 12 in a patient record 3. The structured document 12 that represents a structured data set is stored on the local computer 8 and should be inserted into the patient record 3 on the server 2. A further possibility for an access that initiates the inventive method is the opening of a structured document 5 from the patient record 3. Using the base data set 4, the user already has located the correct patient record 3 and now would like to view one of the documents 5 stored there. Furthermore, the access can also be an opening of a patient record 3. The alteration with regard to a patient record 3 is also contained herein. At this point in time, other structured data sets can be opened or, respectively, be in processing that are not necessarily associated with the corresponding patient. The reading the structured data of an electronically-readable card 14 can also be an access that begins the inventive method.

Additionally (and not shown here), the method can be started upon storage of an altered structured data set in a patient record 3 in order to check for the possibility of changed patient identification data in this structured data set.

In step S2 the patient identification data 11 are then determined from the base data set 4 as well as the patient identification data (for example 13, 19), from the structured data set (thus, for example, the structured data set 12, the structured data set 18) or one of the structured documents 5. Given an access to a structured data set, whereby the simultaneous access to a number of structured data sets is also conceivable (for example upon placement of a plurality of structured documents or a plurality of electronic prescriptions in the patient record 3), the patient identification data are determined from the structured data set or structured data sets which is/are accessed. If a patient record 3 is opened, the determination of the patient identification data in particular concerns the patient identification data 19 of the at least one opened structured data set 18 that is in particular directly shown on the display device 17.

A comparison of the patient identification data that were just determined now ensues in step S3. Which features are compared is determined according to a comparison data set that is known to the program means 9. The comparison data set, which can be stored either in the patient record 3 or on the local computer 8, accordingly includes information about which features should actually be compared. Such features can be, for example, the first name, the last name, the address, the birth date, a health insurance number, a medical characteristic or other patient-specific information. Since all of this information is not always present in the structured data sets, a minimum is suggested that allows a reliable association but does not require too many checks of features. A combination of first and last name of the patient has hereby proven to be appropriate as a minimum data set.

If a difference is established (an error accordingly exists), the method is continued in the step S4. A warning to the user is output via the display device. This warning can be kept general, for example as a simple indication of a possible association error, but also can include information advantageous for the user such as, for example, the specification of corresponding file names in which features of the error occurred, how the features read in the two items of patient information, information about the severity of the error or further information. The user can thereupon resort to further measures at the end. For example, a manual checking of the association can occur; association errors can be corrected, possibly after inquiry with the patient, and in each case incorrect diagnoses or medical findings due to an incorrect association are avoided.

In step S4 a marking of the structured data set as possibly plagued with association errors can possibly also ensue, in particular when this is stored in the electronic patient record 3. Alternatively or in addition, it is possible to enter the data set in which a possible association error was established into a list 10 that is in particular likewise stored in the patient record 3. The list can also accommodate additional information such as, for example, the point in time of the occurrence of the error, the type of the error, etc.

After step S4, or if no difference was determined between the patient identification data in the scope of the comparison data set, the method is ended in step S5.

Although modifications and changes may be suggested by those skilled in the art, it is the intention of the inventors to embody within the patent warranted hereon all changes and modifications as reasonably and properly come within the scope of their contribution to the art.

We claim as our invention:

1. A method for association checking of structured data sets, from which patient identification data are determined in a patient administration system comprising electronic patient records that respectively comprise a structured base data set containing patient identification data, comprising the steps of:
accessing at least one of a patient record and a structured data set thereof;
upon said access, automatically determining patient identification data from the just-accessed structured data or a structured data set that is already opened, and comparing the determined patient identification data with said patient identification data of said base data set; and
emitting a humanly perceptible warning if correspondence is not found, as a result of the comparison, between the determined patient identification data and the patient identification data of the base data set.

2. A method as claimed in claim 1 comprising employing, as any of said structured data sets, a document according to Sciphox standard, a document according to the XML standard, a document according to the xDT standard, a document according to the XDS standard, a document according to the DICOM standard, a document according to the HL7 standard, data from an electronically readable card, data from an electronically-readable personal identification, data from a credit card, and an electronic medical prescription.

3. A method as claimed in claim 1 comprising accessing said at least one of said patient record or a structured data set thereof by an access event selected from the group consisting of placing a structured document in the patient record, opening a structured document from the patient record, and importing a structured document from an electronically-readable source into the patient record.

4. A method as claimed in claim 1 wherein accessing said patient record or a structured data set thereof comprises opening the patient record and simultaneously opening at least one structured data set therein or at least one structured data set accessible from the opened patient record.

5. A method as claimed in claim 1 comprising accessing said patient record by storing an altered structured data set in the patient record.

6. A method as claimed in claim 1 comprising conducting said comparison using a comparison data set comprising at least one patient identification datum.

7. A method as claimed in claim 6 comprising conducting said comparison using a comparison data set comprising at least one patient identification datum selected from the group consisting of a first name, a surname, a birth date, gender, and address, and a medical characteristic.

8. A method as claimed in claim 1 comprising, upon emitting said warning, automatically performing an action selected from the group consisting of marking the structured data set that was the subject of the comparison and entering the structured data set that was the subject of the comparison in a list of other structured data sets with association errors.

9. A method as claimed in claim 1 comprising storing said patient record in a central server of the patient administration system, and accessing said patient record by establishing communication between said central server and a local computer.

10. A computer for association checking of structured data sets, from which patient identification data are determined, in a patient administration system comprising electronic patient records that respectively comprise a structured base data set containing patient identification data, said computer comprising:
a processor;
an input unit connected to said processor allowing access, via said processor to a patient record or a structured data set thereof;
said processor, upon accessing said patient record or said structured data set thereof, automatically determining patient identification data from the just-accessed structured data set or a structured data set that has already been opened and automatically comparing the determined patient data with patient identification data of said base data set; and
a display connected to said processor, said processor automatically generating a warning at said display if, as a result of said comparison, correspondence between the determined patient identification data and the patient identification data of the base data set does not exist.
